(19) United States
(12) Patent Application Publication
(10) Pub. No.: US 2014/0120028 A1
(43) Pub. Date: May 1, 2014

(54) Proximate atom nanotube growth

(71) Applicant: Bryan Edward Laubscher, Olympia, WA (US)

(72) Inventor: Bryan Edward Laubscher, Olympia, WA (US)

(21) Appl. No.: 13/694,088

(22) Filed: Oct. 29, 2012

(51) Int. Cl. B01J 19/00; C01B 31/02

(52) U.S. Cl. CPC B01J 19/0093; C01B 31/0226; B82Y 40/00
USPC 423/447.3; 422/129; 422/186.01; 422/119; 977/843

(57) ABSTRACT

Disclosed is a proximate atom nanotube growth technology capable of continuously growing long, high quality nanotubes. The current invention represents a departure from chemical vapor deposition technology as the atomic feedstock does not originate in the gaseous environment surrounding the nanotubes. The technology mitigates the problems that cease carbon nanotube growth in chemical vapor deposition growth techniques:
1) The accumulation of material on the surface of the catalyst particles, suspected to be primarily amorphous carbon.
2) The effect of Ostwald ripening that reduces the size of smaller catalyst particles and enlarges larger catalyst particles evolving the catalyst particles to a size range distribution incapable of supporting carbon nanotube growth.
3) The effect of some catalyst materials diffusing into the substrate used to grow carbon nanotubes and ceasing growth when the catalyst particle becomes too small.

### BACKGROUND OF THE INVENTION

1. Field of the Invention

The present invention relates to the growth of nanotubes (NTs). The growth is accomplished by transporting the feedatoms of the NT to the catpar of the NT without the atom being chemically bound to a molecule in the atmosphere environment that surrounds the growing nanotube. The current situation can be illustrated by considering the example of carbon nanotubes (CNTs).

Manmade CNTs are created by various means. Consider one of the most useful techniques, chemical vapor deposition (CVD). Basically, the CVD process involves a carbon bearing gas as a constituent of the atmosphere in a reaction chamber. Some of these gas molecules react with a catpar in the chamber and if the temperature, partial gas pressure and many other parameters are correct, the carbon atom migrates into or onto the surface of the catpar and a CNT will grow out of the catpar. This process is quite popular because the CVD process, in general, has proven to be extremely useful, over many decades, in other endeavors including semiconductor microcircuit fabrication. However, there are drawbacks when this technology is used for CNT growth.

The first drawback is that although initial growth of the CNTs is quite rapid, the growth quickly slows to a crawl and for all intents and purposes stops. Breakthroughs have been made that allow the growth to continue perceptibly, albeit slowly, but a second problem comes into play. The already formed CNTs are immersed in an environment of hot, carbon bearing gasses. Reactions continue on the surface of the CNTs that create imperfections in their highly structured carbon lattice. These imperfections dramatically degrade the physical properties of the CNTs. The longer the growth continues in this environment, the more damage is done to the CNTs. Therefore significant quantities of long (≧1 centimeter (cm) for CNTs, many cm for BNNTs), highq CNTs are impossible to fabricate. For over a decade, researchers have been trying to find the “right set” of CVD parameters to produce long, highq CNTs without success.

Causes of the dramatic slowdown of CNT growth during the CVD process are currently understood to include:
1) The accumulation of material on the surface of the catpar, suspected to be carbon in the form of amorphous carbon. This coating reduces the surface area of the catpar thereby decreasing the opportunity for carbon atoms, appropriate to combine with the growing CNT, to either pass into the catpar or migrate on its surface to the CNT growth location. Thus CNT growth is slowed or terminated.
2) The effect of Ostwald ripening tends to reduce the size of small catpars and increase the size of large catpars by mass transfer from the small to the large. Conceptually this is because small particles are thermodynamically less stable than larger particles. This thermodynamically-driven process is seeking to minimize the system surface energy. The catpar size is important since CNT growth will cease (or not begin in the first place) if the catpar is too large or too small.
3) Although substrates upon which CNTs are grown can be many different substances, the most common substrate is silicon dioxide, in part because of the decades of experience with it in the semiconductor industry. Silicon dioxide was thought to be impervious to catalyst elements but in CNT fabrication it has been found that at least some catalyst materials can diffuse into the silicon dioxide layer. Thus the effective size of the catpar gets smaller and can become incapable of supporting CNT growth. Other substrates may be porous to catalyst materials as well.

2. Description of the Prior Art

U.S. Pat. No. 7,045,108 describes the growth of carbon nanotubes on a substrate and the subsequent drawing of those CNTs off the substrate in a continuous bundle. The abstract states: A method of fabricating a long carbon nanotube yarn includes the following steps: (1) providing a flat and smooth substrate; (2) depositing a catalyst on the substrate; (3) positioning the substrate with the catalyst in a furnace; (4) heating the furnace to a predetermined temperature; (5) supplying a mixture of carbon containing gas and protecting gas into the furnace; (6) controlling a difference between the local temperature of the catalyst and the furnace temperature to be at least 50.degree. C.; (7) controlling the partial pressure of the carbon containing gas to be less than 0.2; (8) growing a number of carbon nanotubes on the substrate such that a carbon nanotube array is formed on the substrate; and (9) drawing out a bundle of carbon nanotubes from the carbon nanotube array such that a carbon nanotube yarn is formed.

The technique described in the previous paragraph is a representative example of the popular and useful “forest growth” of CNTs and the drawing of a CNT bundle from the forest. It does not discuss any technique for mitigating the causes for CNT growth slowdown.

U.S. Pat. No. 8,206,674 describes a growth technique for boron nitride nanotubes (BNNTs). From the abstract: Boron nitride nanotubes are prepared by a process which includes: (a) creating a source of boron vapor; (b) mixing the boron vapor with nitrogen gas so that a mixture of boron vapor and nitrogen gas is present at a nucleation site, which is a surface, the nitrogen gas being provided at a pressure elevated above atmospheric, e.g., from greater than about 2 atmospheres up to about 250 atmospheres; and (c) harvesting boron nitride nanotubes, which are formed at the nucleation site.

The above technique forms centimeter long boron nitride nanotubes using laser ablation of the boron into a nitrogen atmosphere. The growth occurs at a rough spot around the ablation crater and the growth streams in the direction of the nitrogen flow. A catalyst material need not be present. The technology does not allow for the control of growth or the use of this laser ablation technology to grow carbon nanotubes.

U.S. Pat. No. 8,173,211 describes CVD CNT growth process that is continuous. From the abstract: A method of production of carbon nanoparticles comprises the steps of: providing on substrate particles a transition metal compound which is decomposable to yield the transition metal under conditions permitting carbon nanoparticle formation, contacting a gaseous carbon source with the substrate particles, before, during or after said contacting step, decomposing the transition metal compound to yield the transition metal on the substrate particles, forming carbon nanoparticles by decomposition of the carbon source catalysed by the transition metal, and collecting the carbon nanoparticles formed.

The technique described in the previous paragraph is a the technique in which the catalyst is dispersed into the carbon-bearing gas flow of the reactor. It produces CNTs of up to approximately 0.5 mm length. The CNTs appear as smoke and can be drawn off continuously. However, the technology has been unable to grow long, highq CNTs.

### SUMMARY OF THE INVENTION

The present invention is a technology for growing NTs by transporting the feedatoms of the NT to the catpar of the NT without the atom being chemically bound to a molecule in the atmosphere environment that surrounds the growing NT. Conceptually, various mechanisms can be used to transport feedatoms to the catpar with the proper energy to combine with the growing NT. One possible embodiment is to use an atomgun to propel the feedatoms to the surface of a catpar with the appropriate energy to facilitate the process that results in the feedatoms becoming a part of the NT growing from the catpar.

The present invention circumvents unwanted, extraneous chemical reactions that occur at the catpar and the NT that arise from the gasses comprising the atmosphere in the reaction chamber by eliminating the need for reactive gasses. Additionally, the atmosphere of the reaction chamber can be controlled to decrease or eliminate the effects of the Ostwald ripening process because that environment is not being controlled to promote carbon reactions that release the carbon from a gas at the surface of a catpar.

The present invention includes the recognition that enabling the growth of highq, long (≧1 centimeter (cm) for CNTs, many cm for BNNTs) NTs represents a fundamental breakthrough. With such a technology, industrial processing of long and highq NTs is within reach. Moreover, industrial production for nanotubes will lower the cost and increase the availability of nanotubes to allow a materials revolution on Earth. This materials revolution will enable the use of nanotubes in high strength materials, electrical conductors, semiconductors, electrical components, electrical micro and nano circuits, and sensors. The most extreme example of the benefits may be that high strength CNT materials will enable the Space Elevator, thereby opening the resources of space to mankind in the form of enhanced Earth observation, space-based solar power, asteroid mining, planetary defense and colonization of the moons and planets of our solar system!

### BRIEF DESCRIPTION OF THE DRAWINGS

FIG. 1 illustrates the best mode of the Proximate Atom Nanotube Growth according to the present invention.

FIG. 2 is a variation of the best mode shown in FIG. 1 in which the tunnel runs at angle other than 90 degrees from the substrate plane.

FIG. 3 is a variation of the best mode shown in FIG. 1 in which the tunnel is 90 degrees from the substrate plane; but not under the catpar; and magnetic fields are used to accelerate the feedatoms onto the catpar.

FIG. 4 illustrates a possible embodiment of the invention in which a laser and an electric field is used to propel the feedatoms onto the catpar.

FIG. 5 illustrates another embodiment of the invention in which a laser ablates the feedatoms off a surface and onto the catpar.

FIG. 6 illustrates yet another embodiment of the invention in which feedatoms are transported to the catpar as a constituent of a catalyst flow.

FIG. 7 illustrates an industrial embodiment of the current invention in which atomguns are used to transport feedatoms to a large array of substrates growing CNTs.

FIG. 8 illustrates an industrial embodiment of the current invention in which the flowing catalyst embodiment is transporting feedatoms to a large array of substrates growing CNTs.

### DETAILED DESCRIPTION OF THE INVENTION

### 1. Definitions

Feedatom—When used herein shall mean an atom or molecule that is a chemical constituent of a nanotube: the atomic feedstock of a nanotube.

Atomgun—When used herein shall mean an atomic or molecular ion source capable of accelerating ionized feedatoms to energies sufficient to transport them to the catpar, such that they arrive with the optimum energy to become a part of nanotube fabrication: an atom gun. In some cases the atomgun may also be used to accelerate catalyst particles.

Catpar—When used herein shall mean a volume of catalyst material, wherein the size, shape and elemental constituents are appropriate for growing a nanotube: a catalyst particle. The catalyst may contain one or more elemental constituents.

Ineratmo—When used herein shall mean the inert, gaseous atmosphere in a CNT growth chamber: an inert atmosphere. If the sides of the substrate are isolated then it refers to the atmosphere on the nanotube growth side (front side) of the substrate. This “inert” atmosphere generally is made up of inert gasses. However, if partial pressures of other gasses, including ones introduced to react with NTs, catpars or free carbon, are introduced into the atmosphere during the growth process, the term interatmo still applies.

Highq—When used herein shall mean nearly defect free: high quality. A highq NT is a nanotube that is nearly pristine, perfect and defect free. As such its tensile strength and electrical properties are maximal.

### 2. Best Mode of the Invention

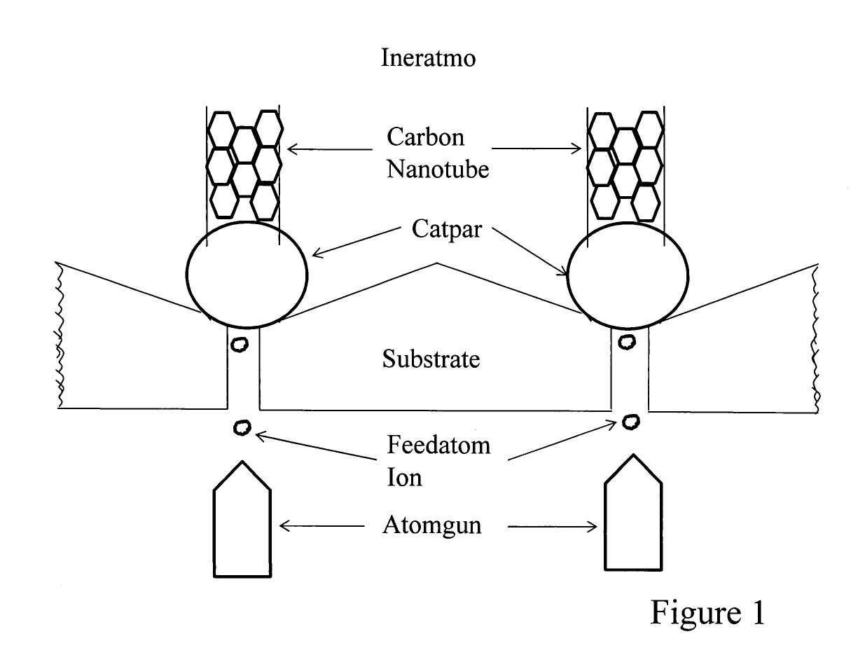

FIG. 1 illustrates the best mode contemplated by the inventor of the Proximate Atom Nanotube Growth according to the concepts of the present invention.

### 3. How to Make the Invention

In a reaction chamber, the system shown in FIG. 1, which illustrates the best mode, grows NTs. An atomgun fires, through a tunnel in the substrate, feedatoms of the proper energy, into a catpar growing an NT. The feedatoms are transported to the catpar with an optimal energy for becoming a part of the NT growing from the catpar. Unwanted, extraneous chemical reactions are mitigated because the nanotubes grow in an ineratmo environment. Surface tension in the catpar allows it to straddle the tunnel. The substrate is contoured to concentrate the catalyst, position the catpar and mitigate Ostwald ripening. The substrate material is a surface impervious to the catalyst material so the catalyst will not migrate through the surface. The ineratmo's constituent gasses and physical characteristics can be chosen to mitigate unwanted, extraneous chemical reactions, suppress Ostwald ripening and support the growth process yielding highq NTs.

The contoured substrate is useful for initially gathering catalyst atoms onto the favored growth site directly above the tunnel. Moreover, a contoured surface may mitigate Ostwald ripening by increasing the energy potential between catpars. The substrate can be heated to optimize the nanotube growth at the catpar. Another embodiment of the current invention is to use a flat substrate.

Catpars that grow NTs are larger in diameter than the NTs but on the order of the size of the NT diameter, that is, one nanometer to tens of nanometers. Therefore, the diameter of the tunnel openings at the substrate are smaller than the catpar diameter but on the order of one nanometer to tens of nanometers. The tunnels may be shaped in various ways other than cylinders if desired.

Prudent choice of the substrate, substrate thin film, catalyst material(s), catpar, ineratmo or combination of these materials and their physical properties may mitigate the dissolution of the catalyst material into the substrate thereby enabling continued NT growth. This unwanted diffusion shrinks the effective size of the catpar and stops NT growth.

Another embodiment could incorporate a thin film across the upper or lower tunnel surface that could support the catpar; isolate the front (ineratmo) and back (atomgun environment) sides of the substrate; and act as a barrier to catalyst diffusion into the substrate. In this case, the feedatoms would require extra energy to penetrate the thin film and would emerge into the catpar with a range of energies since the energy loss of a particle through a thin film is a statistical process. Nonetheless, by tuning the peak of the energy distribution to the optimal energy of a feedatom, NT growth may continue.

An ineratmo mitigates extraneous reactions from atmospheric gasses. Because the feedatoms for NT growth do not come from the atmospheric gasses; the constituent gasses, pressure and temperature of the atmosphere can be adjusted to suppress mechanisms that hinder NT growth. For example, in the case that the substrate heating maintains the catpar and NT growth site optimum temperature, the temperature and pressure of the atmosphere may be lowered to limit the energy of atmosphere-borne free atoms and molecules capable of bonding to the NT or catpar. The atmosphere gasses may be circulated, filtered, exchanged, monitored and/or changed to facilitate control of the constituents, temperature and pressure, thereby maintaining an optimal atmosphere in the reaction chamber. Finally, the atmosphere can be altered during growth process as required to continue growth, change NT characteristics, and/or functionalize NTs.

The atmospheres on the nanotube growth side (front) and atomgun side (back) can be composed of different constituent gasses and have different physical properties as long as barriers are present to separate the atmospheres and the catpar, and its NT growth is not disrupted.

The ineratmo may be modified by the introduction of gasses. One embodiment comprises using gasses to functionalize the growing or already grown NTs before they are removed from the growth environment. In this process, the functionalizing chemicals would be introduced into the ineratmo to chemically bond to the NTs for specific uses or future processing. The composition, temperature and pressure of the ineratmo may be altered to facilitate the functionalization reactions. Moreover, functionalized NTs by altering the materials and/or properties of the: feedstock, feedstock transport, substrate, catalyst, and catpar may be accomplished.

The atomgun is an ion source; an electromagnetic apparatus used to create and accelerate charged particles. In the present invention, ionized feedatoms are transported to the tunnel entrances on the back side of the substrate by acceleration of an atomgun. Requirements for these components of the current invention include the ability to create nearly monoenergetic ions, the capability to steer the beam of ionized feedatoms onto the back of the substrate and sufficiently high current of ions to satisfy the growth requirements of the NTs. In FIG. 1, one atomgun is shown notionally for each tunnel! In reality one atomgun is envisioned as providing feedatoms to many, many tunnels. Another embodiment may use electromagnetic fields to steer and concentrate the feedatom beam of ions onto the back of the substrate.

Ion sources are usually capable of accelerating more than just one atomic species. Therefore, it can be imagined that different ions could be accelerated into the catpar by the atomgun, or other acceleration technologies, in order to replenish catalyst material, alter the composition of the catpar to optimize or control growth and to supply two different elements of feedatoms as in the case of the boron and nitrogen atoms of a boron nitride NT.

When accelerating ions in an atmosphere it is important to minimize the distance that the ions traverse in the atmosphere and the pressure of the atmosphere. The energy spread of the ions (through collisions) and the probability of atoms being scattered out of their path increases as the distance and pressure increase. Therefore, the ineratmo and backside atmosphere will be kept at the minimal possible pressure and the distances the feedatom ions must travel will be kept to a minimum.

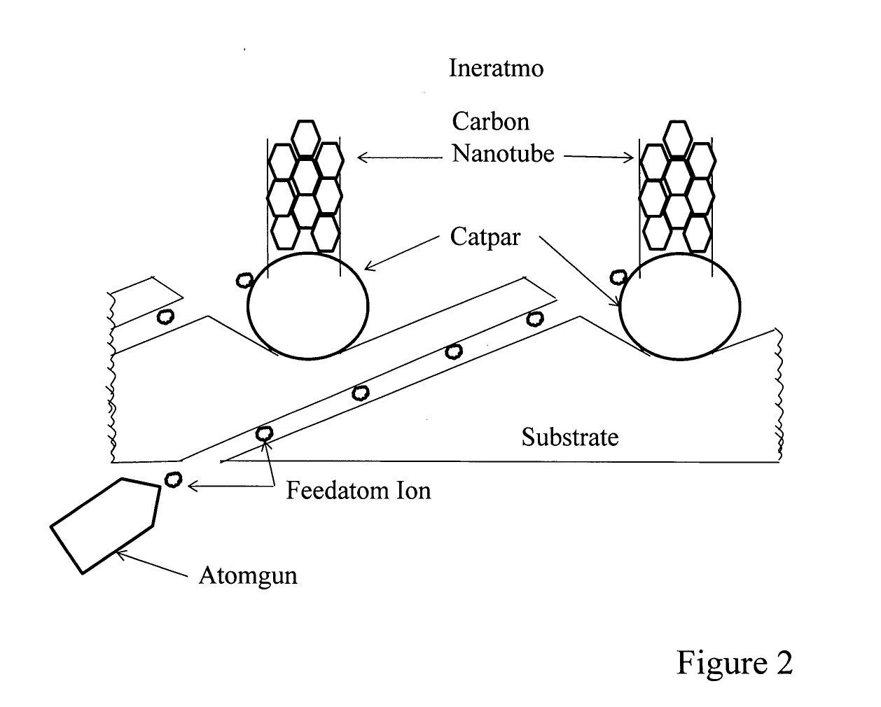

FIG. 2 illustrates an embodiment of the current invention in which the tunnels traverse the substrate at an angle not normal to the substrate plane and offset from the catpar. In the case that the surface tension of the catpar is insufficient to straddle the tunnel through the substrate or for other reasons, the tunnel can be formed as shown in FIG. 2, enabling the physical process of transporting the feedatoms of the optimal energy to the catpar growing an NT through a tunnel angled toward the catpar.

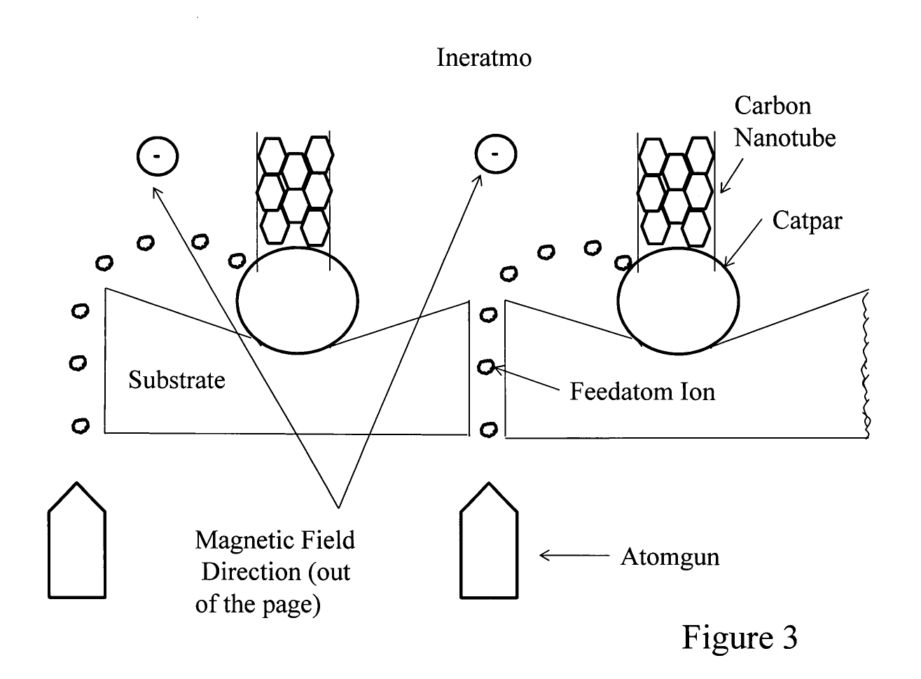

FIG. 3 illustrates an embodiment of the current invention in which the catpar once again does not straddle the tunnel. In the case that the surface tension of the catpar is insufficient to straddle the nanoscopic tunnel through the substrate or for other reasons, the tunnel can be formed as shown in FIG. 3. A magnetic field can be used in the front side of the substrate to accelerate the ionized feedatoms, emerging from the tunnel, in an arc onto the surface of the catpar. In this case the feedatom velocity and magnetic field magnitude and direction must be matched to bring the feedatoms onto the catpar. Electric fields or a combination of electric and magnetic fields may also be used to accelerate the ionized feedatoms onto the surface of the catpar.

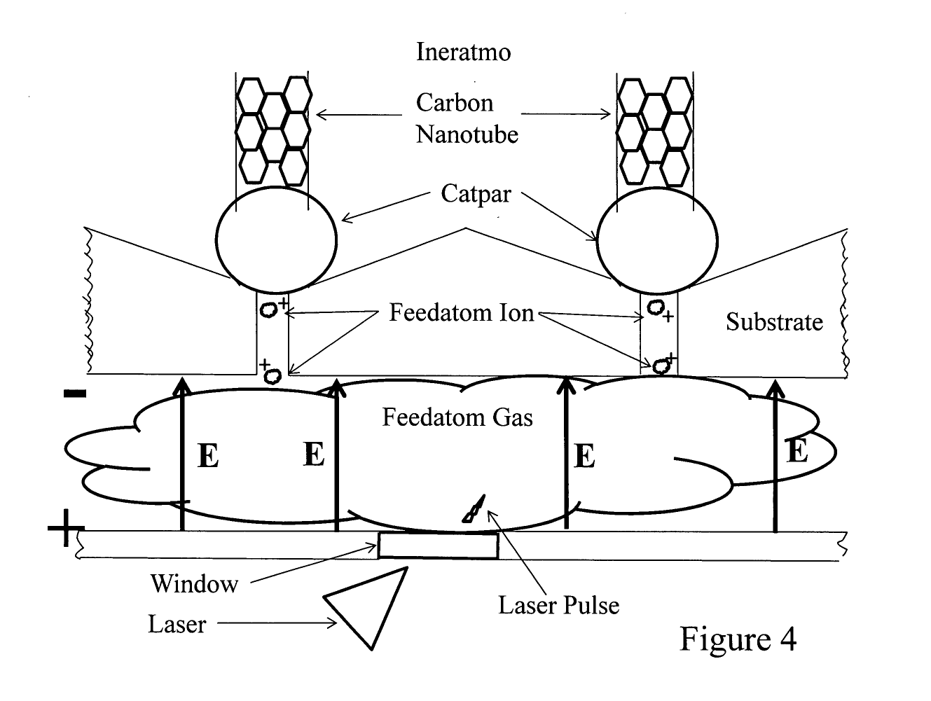

FIG. 4 illustrates a possible embodiment of the current invention. In this version, the atomgun is replaced by an ionizing and accelerating mechanism that uses the substrate. The backside of the substrate (or a coating on the substrate) acts as negative “electrode plate” of the accelerating mechanism and another surface (or a coating on the surface) spaced farther behind the substrate acts as the positive electrode plate. Feedatom or feedatom bearing gas fills the volume in between. A laser or other illumination device, fires ionizing radiation into the feedatom gas through a window and creates some feedatom ions. An electric field is then applied and the positively charged feedatom ions are accelerated toward the backside of the substrate. A few ions are accelerated into the tunnels and impact the catpar. The laser may be pulsed or continuously operated, and the electric field could be pulsed or constantly applied. The laser, feedatom gas, and electric field properties and application may be adjusted to optimize continuous NT growth. The gas could comprise feedatoms and other constitutents that would optimize NT growth. For example, a noble gas that will not be ionized by the radiation wavelength may be added to maintain a desired pressure. Other embodiments may use another ionization method and/or combine electric and/or magnetic fields to accelerate the feedatom ions onto the catpar.

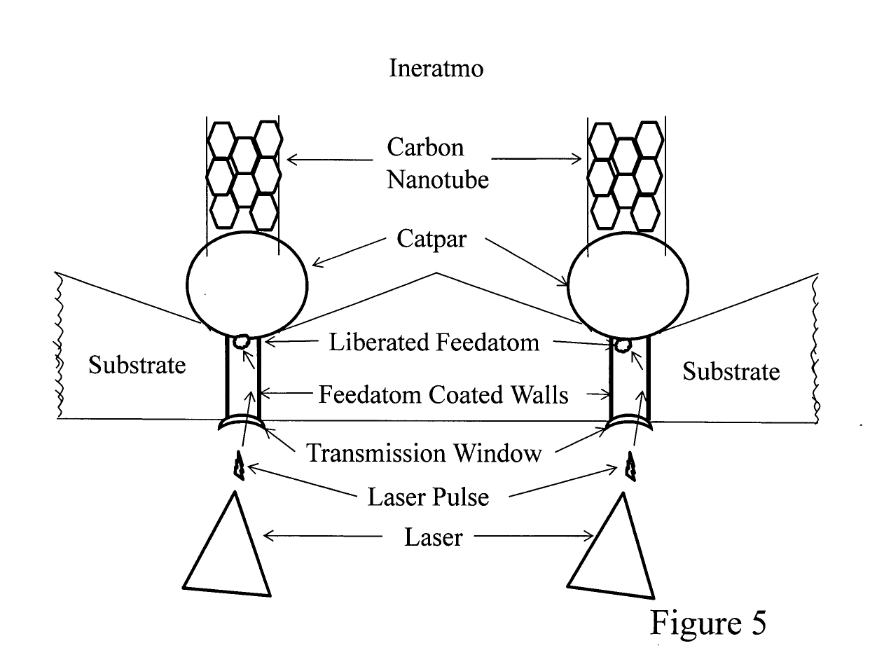

FIG. 5 illustrates another embodiment of the current invention. A high power laser, or other illumination device, fires through a transmission window onto the surface of the tunnel that has been coated with feedatoms. The laser pulse ionizes a number of feedatoms on the tunnel surface and liberates them from the surface. Some of these feedatoms impinge on the catpar and supply the nanotube growth. The laser may be pulsed or continuous wave, and the electric field could be constantly applied or pulsed. The cadence of the laser pulses is adjusted to maintain a sufficient supply of feedatoms to the growth site. Indeed, laser power, pulse length and wavelength as well as the geometry of the tunnel can be adjusted to optimize the feedatoms transported to the catpar.

The energy of these feedatoms is not as controlled as in other embodiments since laser ablation creates a plasma of high temperature. Nonetheless, the catpar will mediate the feedatom's energy and these feedatoms may feed the catpar's NT growth. Also, the transmission window could be a sheet of transmissive material on the bottom of the substrate. This transmissive window or surface could be used to isolate the backside of the substrate from the front side and tunnels, separating the laser environment from the reaction chamber environment. One embodiment of this approach is to eschew the transmissive window altogether and have the laser fire into the tunnel directly.

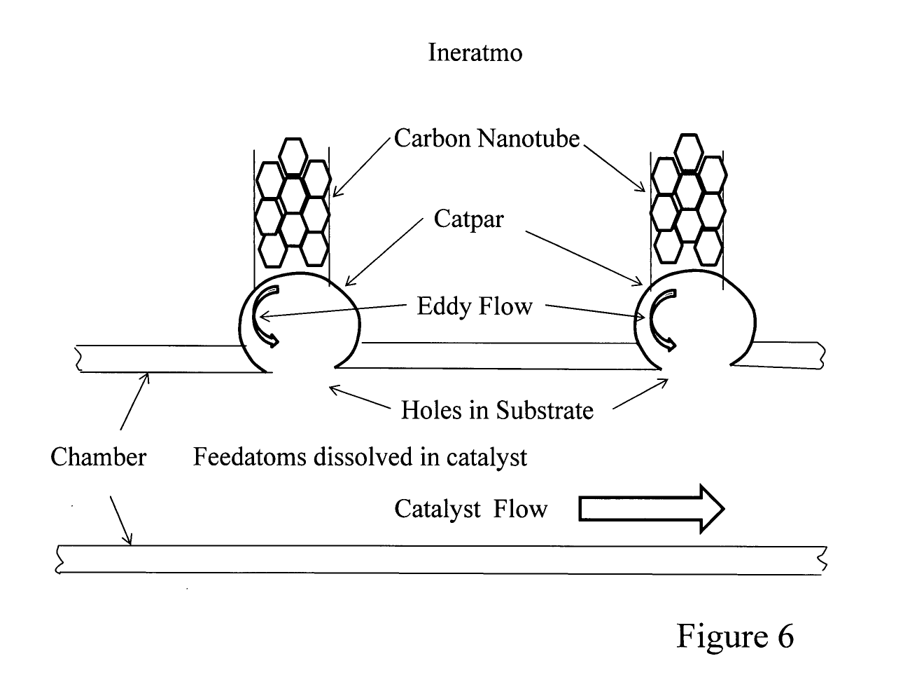

FIG. 6 is an example of one possible embodiment, wherein catalyst material bearing dissolved feedatoms flows in a chamber the top of which is the substrate. A molten catalyst flows in the chamber. Catpars are created by adjusting the pressure slightly to force catalyst through holes in the top of the chamber. The pressure within the flow and in the ineratmo can be adjusted separately or concurrently to create catpars. Feedatoms are dissolved in the catalyst in a precisely controlled process not shown in the figure. As the nanotube growth depletes the feedatom in the catpar catalyst, the depleted catalyst is replaced with feedatom rich catalyst by an eddy current set up by the flow passing underneath the catpar. Additionally, diffusion of feedatoms from the flowing, feedatom rich catalyst reservoir will bring feedatoms into the catpar. The temperature of the catpars and concentration of feedatoms can be adjusted to optimize NT growth.

The dimensions of the chamber may be nanoscopic, microscopic or macroscopic. Indeed the chamber can be of any cross section geometry as long as it provides for catalyst flow and tunnels through which the catpars may be forced. Note that in this embodiment, the eddy flow is enhanced as the tunnel is shortened.

In all of the above embodiments, accurate and precise control of the chemical reaction that forms NTs is enabled by the control of the feedatoms into/onto the catpars as well as the environment within which the reaction is taking place. This environment includes the ineratmo composition, temperature, pressure and density as well as the catpar composition, temperature, pressure and density. Moreover, the various feedatom transport methods to the catpar of the different embodiments and environmental control enable the suppression of other, unwanted chemical reactions, such as amorphous carbon that can stop CNT growth.

The accurate and precise control enabled by the growth technique facilitates the maintaining or changing of growing NT properties, such as NT diameter and chirality, during the growth process. The control is accomplished by altering the materials and/or physical properties of the feedatoms, feedatom transport, substrate, catalyst, catpar, and/or ineratmo. Thus NTs of novel properties could be produced and tailor-made to specific applications. One example is to constantly increase the catpar size (within limits that permit continued growth) so that the NT may undergo transitions to larger diameters.

Real time diagnostic measurements may be employed to measure and control the growth and functionalization of NTs. These diagnostics include the NT growth rate and structure; catalyst temperature, pressure, composition; feedatom transport; and ineratmo composition, temperature and pressure.

Proximate Atom Nanotube Growth technology may also be used to grow assemblages of atoms thereby forming molecules, structures, shapes and machines in an accurate and controlled manner. These assemblages of atoms include crystals, allotropes of an element, polymorphisms of compounds, polymers, minerals, metals, and polyamorphisms of amorphous materials. These processes may or may not require a catalyst to facilitate the formation of the assemblage.

The examples outlined in the present invention have all included the transport of a feedatom to a catpar. Control of feedatom transport at the sub-nanoscopic level and with precise energy and orientation, will enable fundamental building processes both catalytic and independent of a catalyst. In this case, the feedatoms are transported to an atomic, target site with the optimum energy distribution and orientation to promote bonding at its precise atomic position and with its intended bond(s) in the assemblage of atoms. The construction of designed structures will open up possibilities for materials science, physics, chemistry, medicine, biology, electronics/electromagnetics, optics, agriculture, and industrial and consumer products that are now undreamt.

### 4. Examples

There are technologies that exist, are under development, or are at the conceptual level for forming nanoscale tunnels in substrates:
1) Laser drilling techniques;
2) Focused ion beam drilling;
3) Forming boules (in analogy with microchannel plate fabrication but at smaller scales) with a microscopic tube pattern filled with sacrificial material, drawing these structures to the level that the tubes are of nano-scopic cross section, thin slicing the boules transverse to the tubes, then etching away the sacrificial material with a plasma torch.
4) Creating a forming die out of CNT material through patterned growth and subsequent manipulation, forming a ceramic material around the CNT forming die, and destructively removing CNT forming die material with a plasma torch.

Technique #4 above is also a possible approach to creating the chamber illustrated in FIG. 6. The CNT forming die would be formed as two separate pieces. A forest growth of CNTs (on a substrate that can survive the processing and be removed) is the forming die for the top surface with nano-scopic holes. A second piece is a cylindrical assembly of CNTs for the flow chamber. These two assemblies would be combined and the ceramic material formed over them, forming the flow chamber volume and its top surface with tiny holes. Finally, the CNT forming die (and substrate) would be removed, probably with a plasma torch that leaves the ceramic undamaged.

Generally, rough surfaces are easier to produce than flat, smooth surfaces. Thus there are many ways to make rough substrates. However, if the contoured surface structure is important then a controlled way to create the contours of the substrate surface may be used. One possible example is to use laser ablation. Indeed, one could create an ablation “crater” and then drill a hole through the bottom of the crater. This could be accomplished by first defocusing slightly the laser beam to ablate the crater and then focusing and collimating the beam to drill a hole through the substrate. In this case the drilling process may be seen as sequentially blasting many little craters vertically until the substrate is penetrated.

The surface of the substrate may have any one of various hole patterns. An array of regularly spaced holes could be chosen to grow NTs in bulk whereas a particular pattern could be used to fabricate: 1) electronic components and circuits; 2) single sensors and arrays; 3) receivers, rectennas or electromagnetic radiation emitting structures; 4) surface geometries to promote or prevent biological growth; 5) surfaces with special optical, reflective, interference or diffractive properties; 6) surfaces to promote or prevent chemical reactions; 7) structures with certain material properties including strength, hardness, flexibility, density, porosity, etc.; and 8) surfaces that emit particles such as electrons under electrical stimulation (field emission).

Continuous replenishment of feedatoms to the catpars growing NTs and the mitigation of the phenomena that stop NT growth described by the various embodiments above enables continuous growth of NTs. This continuous growth enables the industrialization of bulk NT growth as well as patterned NT growth described in the previous paragraph.

### 5. How to Use the Invention

In the research laboratory, the Proximate Atom Nanotube Growth technology will enable researchers to grow large amounts of long, highq NTs thereby stimulating research into the properties of the NTs and the macroscopic assemblages formed using these materials. In the case of CNTs these properties include very high tensile strength, high thermal conductivity, for some chiralities low conductivity and the ability to sustain very high electrical current densities, and for other chiralities semiconductor properties. In the case of boron nitride nanotubes interesting properties include high tensile strength, high thermal conductivity, low electrical conductivity and neutron absorption based upon the presence of boron. Indeed, the long, highq NTs may reveal properties and applications that are not possible with the currently available NTs. Moreover, the long, highq nanotubes can be used to construct: 1) enhanced strength structures; 2) enhanced conductivity conductors, wires, microscale and nanoscale integrated circuits, microscale and nanoscale transistors, diodes, gates, switches, resistors, capacitors, single sensors and arrays; 3) receivers, rectennas or electromagnetic radiation emitting structures; 4) surface geometries to promote or prevent biological growth; 5) surfaces with special optical, reflective, interference or diffractive properties; 6) surfaces to promote or prevent chemical reactions; 7) structures with certain material properties including strength, hardness, flexibility, density, porosity, etc.; and 8) surfaces that emit particles such as electrons under electrical stimulation (field emission).

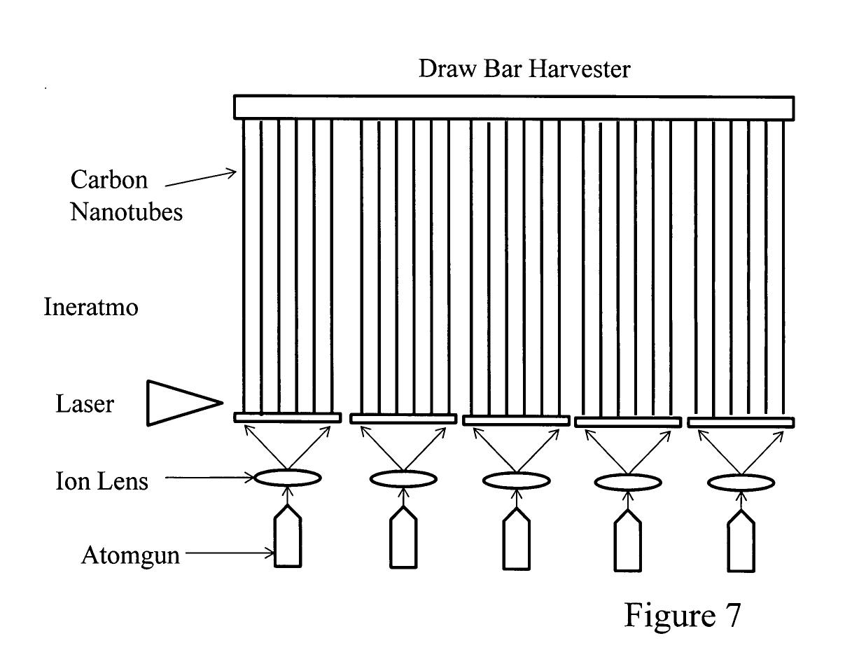

The inventor envisions transforming the present invention into an industrial process in which a vast amounts of long, highq NTs are created. FIG. 7 illustrates schematically this vision. FIG. 7 shows the side view inside a reaction chamber. Five assemblies each consisting of a substrate with catpars arranged on it sitting above an atomgun. In between is an electromagnetic ion lens that transports the ions from the atomgun onto appropriate trajectories toward the backside of the substrate. Above the front surface of the five substrates is a “draw bar harvester”. When the NT growth has progressed for a time, the bar moves down, attaches to the growing NT surface and then rises in cadence with the growth. When the NTs are ready to be harvested, an industrial laser cuts the NTs off, above the substrate and catpar levels. The bar then transports the harvested NTs out of the reaction chamber to a processing location.

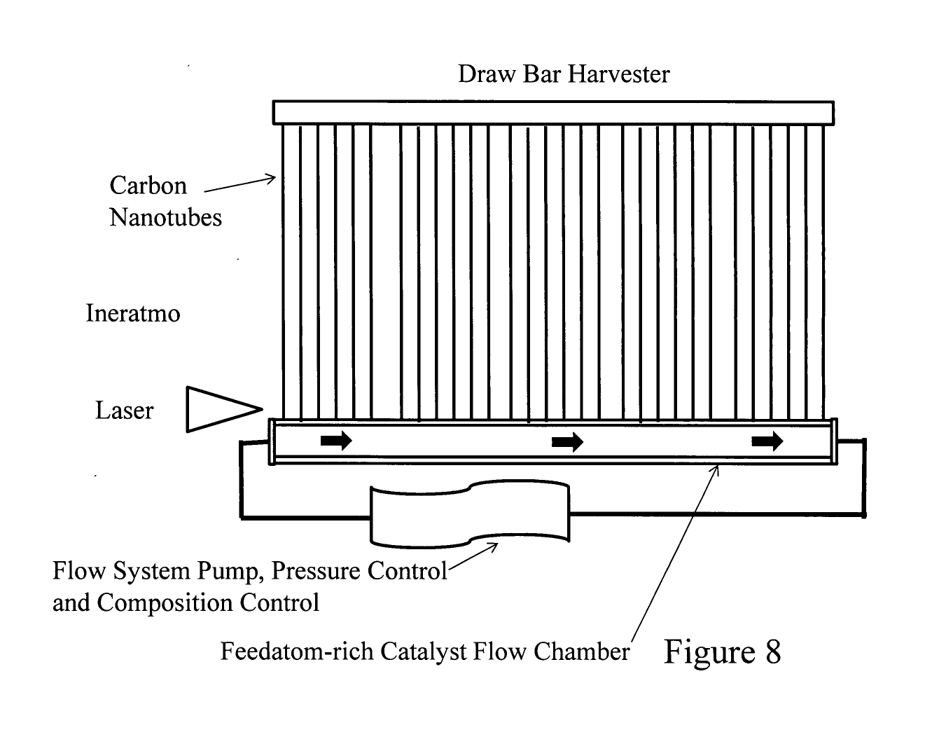

FIG. 8 illustrates another embodiment of an industrial process for the Proximate Atom Nanotube Growth Technology. The difference is that the flowing catalyst feedatom transport system (see FIG. 6) replaces the atomgun of FIG. 7.

The industrialization concepts described above and illustrated in FIGS. 7 and 8 run continuously and are modular so can be scaled up to any size desired.

The procedure for using the Proximate Atom Growth Technology, based on the embodiment of FIG. 1, the best mode, in the laboratory or in an industrial setting, could include the steps of: 1) contouring and forming tunnels in the surface of a substrate; 2) laying down a thin film of catalyst on the surface of the substrate; 3) installing the substrate in a reaction chamber; 4) arranging the atomgun and ion lens to transport feedatoms to the backside of the substrate; 5) sealing the experiment chamber; 6) replacing the atmosphere in the reaction chamber with an ineratmo; 7) raising the temperature of the substrate to liquefy the catalyst on the substrate so it forms catpars; 8) adjusting the interatmo pressure and composition to operating configuration 9) configuring all the temperatures of the substrate, catpars, interatmo and feedatom transport system to their proper operating level; 10) initiating the feedatom transport system; 11) monitoring the NT growth with the real time diagnostics of the experiment chamber 12) optimizing the physical properties of the substrate and feedatom transport system as well as the physical properties and composition of the feedatoms, catalyst, catpars, ineratom to optimize growth; 13) when the growth goal has been reached, turning off the feedatom delivery system; 14) replacing the interatmo with air; 15) opening the reaction chamber 16) removing the substrate and its NTs from the reaction chamber; 17) performing diagnostic measurements on the NTs produced; 18) removing the NTs from the substrate; 19) processing the NTs into a product.

The procedure for using the Proximate Atom Growth Technology, based on the embodiment of FIG. 8, in the laboratory or in an industrial setting, could include the steps of paragraph [0067], wherein the steps numbered 2-10 are replaced by: 1) mounting the substrate onto the catalyst flow chamber; 2) installing the catalyst flow chamber and its catalyst pump system into the reaction chamber; 3) adding the catalyst and feedstock to the catalyst pump system; 4) sealing the experiment chamber; 5) replacing the atmosphere in the reaction chamber with an ineratmo; 6) turning on the catalyst pump system and let it stabilize its temperature and pressure and composition of the feedatom rich catalyst; 7) configuring all the temperatures of the substrate, catalyst pump system and interatmo to their proper operating temperatures; 8) adjusting the interatmo and catalyst pressures and compositions to operating configuration and force the catpars onto the substrate surface.

The procedure for using the Proximate Atom Growth Technology, based on the embodiment of FIG. 5, in the laboratory or in an industrial setting, could include the steps of paragraph [0067], wherein the steps numbered 3-4 are replaced by: 1) laying down feedatom stock into the tunnels of the substrate; 2) installing the transmissive surface to the back side of the substrate; 3) installing the substrate in a reaction chamber; 4) interfacing and aligning the illumination system with the backside of the substrate.

The procedure for using the Proximate Atom Growth Technology, based on the embodiment of FIG. 4, in the laboratory or in an industrial setting, could include the steps of paragraph [0067], wherein the steps numbered 3-4 are replaced by: 1) interfacing the feedatom gas chamber and electrode assembly to the substrate; 2) installing the substrate in a reaction chamber; 3) interfacing and aligning the ionizing laser system with the window on the backside of the feedatom gas chamber and electrode assembly.

Industrial manufacturing of long, highq NTs means that these materials will be plentiful and inexpensive. In the case of carbon nanotubes, with their remarkable tensile strength and electrical properties, new ways of building existing commodities will be developed and new products will be invented using the superior material properties. CNT high strength material, possibly exceeding in tensile strength all existing materials by an order of magnitude or more, will revolutionize life on Earth. Additionally, with patterned growth technology, CNT electrical components created at the nanometer scale lengths will enable smaller, lower power integrated circuits and will transform human society. The most extreme example of the benefits may be that high strength CNTs will enable the Space Elevator, thereby opening the resources of space to mankind in the form of enhanced Earth observation, space-based solar power, asteroid mining, planetary defense and colonization of the moons and planets of our solar system!

It will be appreciated by those skilled in the art that the present invention is not restricted to the particular preferred embodiments described with reference to the drawings, and that variations may be made therein without departing from the scope of the present invention as defined in the appended claims and equivalents thereof.

What is claimed is:

1. A Proximate Atom Growth Technology comprising: a substrate appropriate for growing NTs; catpars arranged on the surface of the flat substrate; tunnels through the substrate from the backside to the vicinity of the catpars; a technique for transporting the feedatoms onto the catpar; an ineratmo that is the environment of the front side of the substrate, the volume in which the catpars and NTs reside and possibly the backside as well; wherein long, highq NTs are grown continuously.

2. A Proximate Atom Growth Technology according to claim 1, wherein the technique for transporting a feedatom onto the catpar uses an atomgun; with or without an electromagnetic means; to transport the feedatoms onto the backside of the substrate where some pass down the tunnels onto the catpar.

3. A Proximate Atom Growth Technology according to claim 1, wherein atomguns or other acceleration technologies accelerate ions into the catpar; in order to replenish catalyst material or alter the composition of the catpar; to optimize or control growth and to supply two different elements of feedatoms as in the case of the boron and nitrogen atoms of a boron nitride NT.

4. A Proximate Atom Growth Technology according to claim 1, wherein the technique for transporting a feedatom onto the catpar uses an acceleration mechanism comprising: a volume behind the substrate filled with feedatom or feedatom bearing gas; an accelerating electromagnetic field that may be pulsed or continuous; a technique of ionizing some of the feedatoms; wherein some feedatoms in the gas are ionized; and then the acceleration mechanism propels the feedatom toward the substrate where some pass down the tunnels onto the catpar.

5. A Proximate Atom Growth Technology according to claim 1, wherein the technique for transporting a feedatom onto the catpar uses an acceleration mechanism comprising: an illumination device; feedatom stock in solid form in or around a tunnel in the substrate; wherein powerful illumination pulses, or continuous wave operation, liberates feedatoms from the surface and propels some of them to the surface of the catpar.

6. A Proximate Atom Growth Technology according to claim 1, wherein the technique for transporting a feedatom onto the catpar comprises: a volume below that substrate with catalyst flowing through it; feedatoms dissolved in the catalyst; tunnels through the substrate; wherein the feedatom-rich catalyst forms catpars by being forced up through the substrate; feedatoms are replenished in the catpar by an eddy flow of catalyst material from the flowing catalyst; and/or diffusion replenishes the catpar with feedatoms from the flowing feedatom rich catalyst reservoir.

7. A Proximate Atom Growth Technology according to claim 1, wherein electric, magnetic or a combination of both fields are used to accelerate the feedatoms onto catpars on the front side of the substrate after emerging from a tunnel.

8. A Proximate Atom Growth Technology according to claim 1, wherein the surface of the substrate that contains the catpars and growing NTs is contoured to facilitate the gathering of the catalyst into catpars and to mitigate Ostwald ripening.

9. A Proximate Atom Growth Technology according to claim 1, wherein diagnostics are used to monitor the growth of NTs in the reaction chamber in real time to facilitate the optimization of the growth process.

10. A Proximate Atom Growth Technology according to claim 1, wherein the growing NT properties and/or optimization are purposefully maintained or changed by altering the materials and/or physical properties of the feedatoms, feedatom transport, substrate, catalyst, catpar, and/or ineratmo.

11. A Proximate Atom Growth Technology according to claim 1, wherein the NTs are purposefully functionalized by altering the materials and/or properties of the: feedstock, feedstock transport, substrate, catalyst, catpar, and/or ineratmo.

12. A Proximate Atom Growth Technology according to claim 1, wherein any appropriate feedstock, feedstock transport, substrate, catalyst, catpar, ineratmo or combination of these materials or their physical properties are used to grow NTs.

13. A Proximate Atom Growth Technology according to claim 1, wherein any appropriate substrate, substrate thin film, catalyst material(s), catpar, ineratmo or combination of these materials or their physical properties are used to mitigate dissolution of the catalyst into the substrate.

14. A Proximate Atom Nanotube Growth Technology according to claim 1, wherein assemblages of atoms are created; with or without a catalyst; including molecules, structures, crystals, allotropes of an element, polymorphisms of compounds, polymers, minerals, metals, and polyamorphisms of amorphous materials.

15. A Proximate Atom Growth Technology according to claim 1, wherein the substrate may have any one of various hole patterns used to fabricate electronic components and circuits; single sensors and arrays; receivers, rectennas or electromagnetic radiation emitting structures; surface geometries to promote or prevent biological growth; surfaces with special optical, reflective, interference or diffractive properties; surfaces to promote or prevent chemical reactions; structures with certain material properties including strength, hardness, flexibility, density, porosity, etc.; and surfaces that emit particles such as electrons under electrical stimulation (field emission).

16. A Proximate Atom Growth Technology comprising precisely controlled feedatoms that enable the transport of a feedatom to an atomic, target site; said feedatom having the optimum energy distribution and orientation to promote bonding at its precise atomic position; and with its intended bond(s) in the desirable assemblage of atoms.

17. A method for using a Proximate Atom Growth Technology comprising the steps of: 1) contouring and forming tunnels in the surface of a substrate; 2) laying down a thin film of catalyst on the surface of the substrate; 3) installing the substrate in a reaction chamber; 4) arranging the atomgun and ion lens to transport feedatoms to the backside of the substrate; 5) sealing the experiment chamber; 6) replacing the atmosphere in the reaction chamber with an ineratmo; 7) raising the temperature of the substrate to liquefy the catalyst on the substrate so it forms catpars; 8) adjusting the interatmo pressure and composition to operating configuration 9) configuring all the temperatures of the substrate, catpars, interatmo and feedatom transport system to their proper operating level; 10) initiating the feedatom transport system; 11) monitoring the NT growth with the real time diagnostics of the experiment chamber 12) optimizing the physical properties of the substrate and feedatom transport system as well as the physical properties and composition of the feedatoms, catalyst, catpars, ineratom to optimize growth; 13) when the growth goal has been reached, turning off the feedatom delivery system; 14) replacing the interatmo with air; 15) opening the reaction chamber 16) removing the substrate and its NTs from the reaction chamber; 17) performing diagnostic measurements on the NTs produced; 18) removing the NTs from the substrate; 19) processing the NTs into a product.

18. A method for using a Proximate Atom Growth Technology, according to claim 17, wherein the steps numbered 2-10 are replaced by: 1) mounting the substrate onto the catalyst flow chamber; 2) installing the catalyst flow chamber and its catalyst pump system into the reaction chamber; 3) adding the catalyst and feedstock to the catalyst pump system; 4) sealing the experiment chamber; 5) replacing the atmosphere in the reaction chamber with an ineratmo; 6) turning on the catalyst pump system and let it stabilize its temperature and pressure and composition of the feedatom rich catalyst; 7) configuring all the temperatures of the substrate, catalyst pump system and interatmo to their proper operating temperatures; 8) adjusting the interatmo and catalyst pressures and compositions to operating configuration and force the catpars onto the substrate surface.

19. A method for using a Proximate Atom Growth Technology, according to claim 17, wherein the steps numbered 3-4 are replaced by: 1) laying down feedatom stock into the tunnels of the substrate; 2) installing the transmissive surface to the back side of the substrate; 3) installing the substrate in a reaction chamber; 4) interfacing and aligning the illumination system with the backside of the substrate.

20. A method for using a Proximate Atom Growth Technology, according to claim 17, wherein the steps numbered 3-4 are replaced by: 1) interfacing the feedatom gas chamber and electrode assembly to the substrate; 2) installing the substrate in a reaction chamber; 3) interfacing and aligning the ionizing laser system with the window on the backside of the feedatom gas chamber and electrode assembly.
